(19) United States
(12) Patent Application Publication
(10) Pub. No.: US 2017/0117744 A1
(43) Pub. Date: Apr. 27, 2017

(54) PV Ramp Rate Control Using Reinforcement Learning Technique Through Integration of Battery Storage System

(71) Applicant: NEC Laboratories America, Inc., Princeton, NJ (US)

(72) Inventors: Yanzhu Ye, San Jose, CA (US); Ratnesh Sharma, Fremont, CA (US); Feng Guo, Santa Clara, CA (US)

(21) Appl. No.: 15/222,604

(22) Filed: Jul. 28, 2016

Related U.S. Application Data
(60) Provisional application No. 62/246,801, filed on Oct. 27, 2015.

(51) Int. Cl. H02J 7/35; H02J 7/00; H02S 40/38

(52) U.S. Cl. CPC H02J 7/355; H02S 40/38; H02J 7/007

(57) ABSTRACT

Systems and methods are disclosed for storing photovoltaic (PV) generation by applying reinforcement learning (RL)-based control to battery storages for PV ramp rate control; and exchanging energy dynamically to limit a ramp rate of the PV power output and maintaining a battery state of charge level at a predefined level to minimize required battery size and extend the battery life cycles.

The present application claims priority to Provisional Application 62/246,801, the content of which is incorporated by reference.

### BACKGROUND

The present invention relates to management of energy storage systems.

There are more and more PV resources being connected to the conventional weak distribution systems, however, the power generation from renewables greatly depends on the weather condition, which is unpredictable, and variable. The high ramp rate variations of the PV power output will bring significant voltage fluctuations. Severe ramp rate may even cause system stability issues. Therefore, ramp rate control strategies to reduce fluctuations in PV outputs are necessary in order to increase the PV penetration level in the networks.

The integration of energy storage devices with PV system is an effective way to smooth PV output, e.g. the battery energy storage. The ramp rate of PV generation output can be limited by charging and discharging battery storage system. Considering the limited power/energy capacity, the limited life cycles of battery storage devices, unpredictable power generation, dynamic operation environment, and an effective control method of battery storage is required to limit the PV ramp rate.

There are basically two ways for PV ramp rate control, one is energy storage-aided, the other is without energy storage integrated with PV. For those control approaches without energy storage involved, such as inverter-based control approach which curtails the PV output during PV ramping-up events. It has been investigated in literatures that these curtailment approaches lead to a direct energy loss or profit loss; meanwhile, the inverter-based power curtailment approach only works for ramp up events. For the ramp down event, storage devices or other reserve services are still needed to provide supporting power supply.

For those energy storage-based control approaches, most studies use moving average filter or other low-pass filter to control battery operation. The filter-based method can reduce PV output fluctuations, however it may not necessarily control the PV output to a desired ramp rate. And the choice of the moving filter time window will affect the battery operation. For example, the short time windows may be insufficient to counteract high ramp rates, while large time windows may introduce excessive utilization of battery. In some studies the battery SoC is feedback into control loop to maintain the battery energy capacity in range. However, the battery operation is still not being optimized in a way that the required battery capacity is minimized and the life is possibly extended.

### SUMMARY

In one aspect, systems and methods are disclosed for storing photovoltaic (PV) generation by applying reinforcement learning (RL)-based control to battery storages for PV ramp rate control; and exchanging energy dynamically to limit a ramp rate of the PV power output and maintaining a battery state of charge level at a predefined level to minimize required battery size and extend the battery life cycles.

In another aspect, a ramp rate control method includes a reinforcement learning (RL)-based control framework of battery storage system for PV ramp rate control. In RL, the problem can be modeled as the interaction between an objective-oriented controller and an environment with uncertainty. This approach does not require known PV power profiles. Through predetermined control objectives, the PV ramp rate can be directly constrained within limit, meanwhile avoid excessive utilization of battery. So a multi-control objective is constructed to include the success of suppression of PV power ramp rate and minimization of the deviation of battery capacity from pre-defined setting point.

As one type of RL, the Q-learning technique is applied towards the optimal control of battery storage which maximizes the total rewards during the system operation. The reward function is constructed in the way that the above control objectives are minimized.

Advantages of the system may include improved battery operation in that the required battery capacity is minimized and the life is extended. The control framework optimizes battery energy storage for PV ramp rate control. The control approach is able to manage the battery SoC level optimally in order to minimize the required battery capacity, extend the battery life cycles. Other advantages may include one or more of the following:
1. Optimize the battery storage operation policy to effectively control PV ramp rate within limit;
2. Manage the battery SoC level during system operation in order to minimize the required battery capacity, extend the battery life cycles;
3. Multi-objective optimization: suppressing the fluctuation of PV power, and reducing the deviation of battery capacity from predefined setting; and
4. Discrete mode definition: faster operation control.

### BRIEF DESCRIPTION OF THE DRAWINGS

FIG. 1 shows an exemplary PV ramp rate control using reinforcement learning technique through integration of a battery storage system.

FIG. 2 shows an exemplary diagram of battery integration with a PV system.

FIG. 3 illustrates an exemplary control approach for PV ramp down event.

FIG. 4 illustrates an exemplary control approach for PV ramp up event.

FIG. 5 illustrates an exemplary online battery operation updating flowchart.

FIG. 6 shows an exemplary flowchart of Q value updating.

FIG. 7 shows an exemplary operation flowchart of reinforcement learning-based control method of battery storage.

FIG. 8 shows an exemplary system for PV ramp rate control using reinforcement learning technique through integration of a battery storage system.

### DESCRIPTION

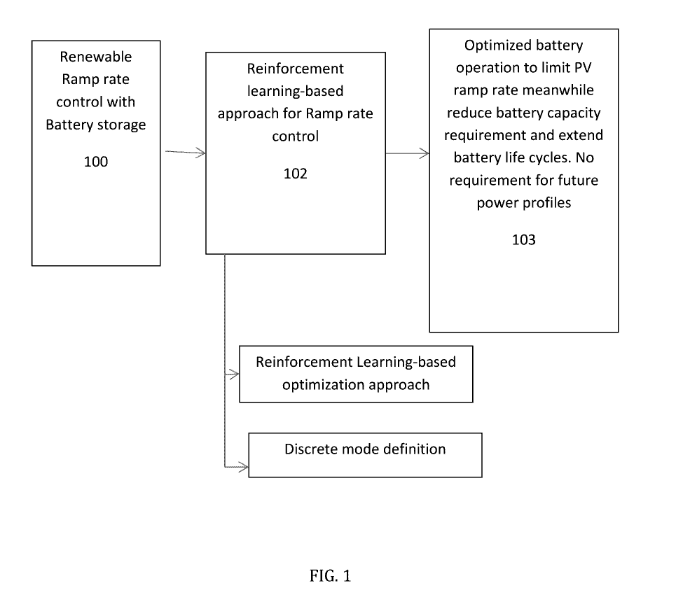

FIG. 1 shows an exemplary PV ramp rate control using reinforcement learning technique through integration of a battery storage system. The system includes a battery storage system 100 with a renewable ramp rate control. The system also includes a module that provides RL-based approach for ramp rate control 102. A module 103 provides optimized battery operation to limit PV ramp rate meanwhile reduce battery capacity requirement and extend battery life cycles. This is achieved with no requirement for PV power profiles.

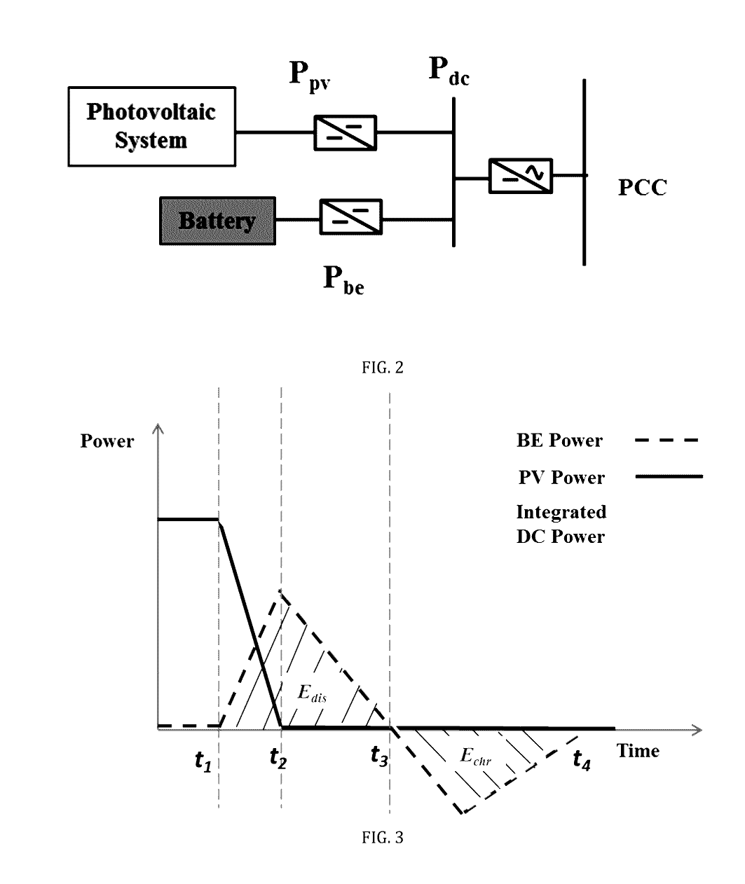

The target system (PV integrated with Battery storage system) is shown in FIG. 2 which includes a solar panel (PV) and an energy storage device such as a battery. While FIG. 2 shows one PV and battery framework of a battery integration with a PV system, there may exist different system frameworks such as a configuration where the battery and PV are directly connected through two separate dc-ac inverters onto PCC. Assume that there is no energy loss of the converters, we have the following power balance equation.

P_{dc}=Pₚᵥ+P_{be} (1)

As shown in FIG. 2, the battery power (P_{be}) is controlled to compensate the fluctuations of PV power generation (Pₚᵥ), so that the ramp rate of the total power output (P_{dc}) to grid can be limited within a desired level.

The desired ramp-rate of P_{dc} is defined as the maximum allowable ramp rate (MARR). The MARR could be defined in different units, e.g. W/sec, kW/min.

The ramp rate of P_{dc} can be described as:

$$\frac{d {P}_{dc}}{d t} = \frac{d {P}_{pv}}{d t} + \frac{d {P}_{be}}{d t} \qquad ( 2 )$$

Assume the sampling time interval is Δt, Eq. (2) can written as

$$\frac{Δ {P}_{dc}}{Δ t} = \frac{Δ {P}_{pv}}{Δ t} + \frac{Δ {P}_{be}}{Δ t} \qquad ( 3 )$$

So that the ramp rate should satisfy

$$\vert \frac{Δ {P}_{dc}}{Δ t} \vert < MARR$$

$$\vert \frac{Δ {P}_{pv}}{Δ t} + \frac{Δ {P}_{be}}{Δ t} \vert < MARR$$

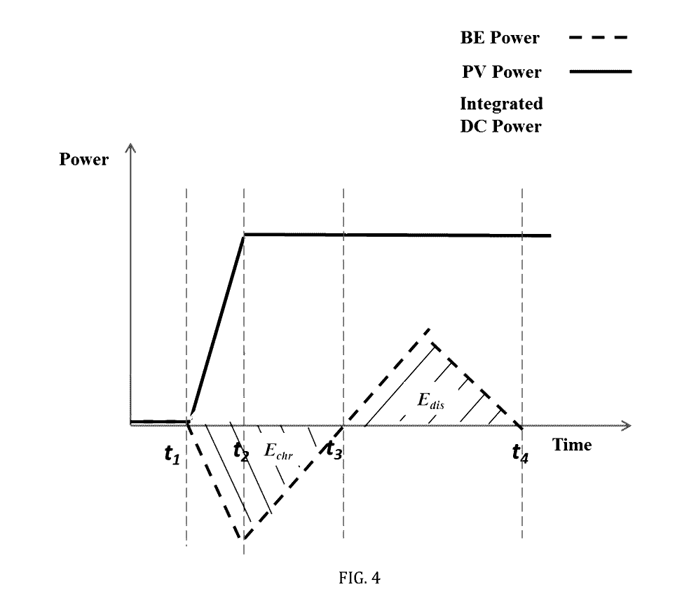

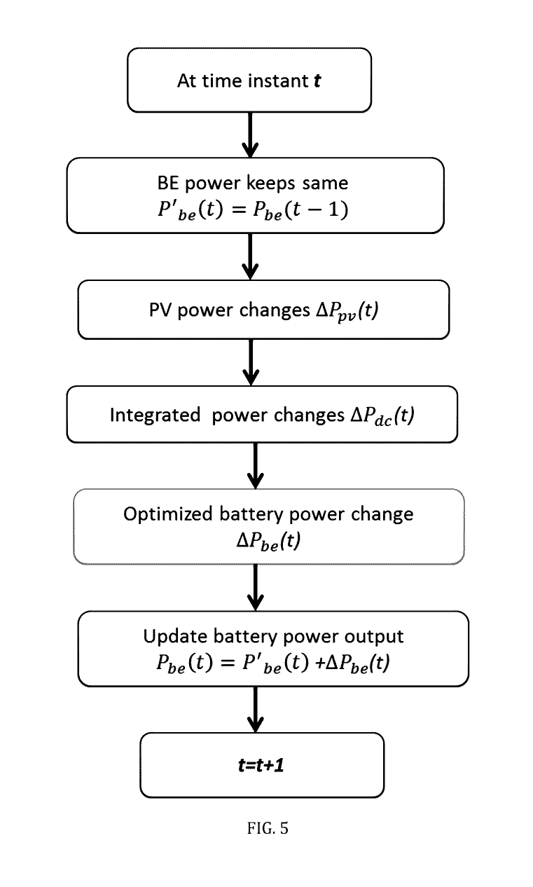

To illustrate the instant ramp rate control method, an illustrative PV power ramp down and the corresponding compensating battery power is shown in FIG. 3 while FIG. 4 illustrates an exemplary control approach for PV ramp up event. The entire procedure is divided into three steps: ramping event time, post-event time, recovery time. During the ramping event time period (t₁˜t₂), the battery is discharged (the red dotted curve) to constraint the ramp rate of P_{dc} within MARR, while during the post-ramp rate event time period (t₂˜t₃), the battery is kept discharged to sustain the ramp rate of P_{dc} within MARR until the battery power decreases into zero. During the recovery period (t₃˜t₄), the battery is controlled to be charged while the ramp rate of P_{dc} is still kept within MARR. FIG. 4 shows the similar procedure for ramping up event. The shade region in FIG. 3 and FIG. 4 indicates the charged (E_{chr}) or discharged (E_{dis}) battery energy.

There are several variables which need to be defined or optimized during the ramping control process:
RR_{dc}: the targeted ramp rate of integrated DC power;
RR_{be,event}: the ramp rate of BE power during ramping event time period (t₁˜t₂)
RR_{be,post-event}: the ramp rate of BE power during post-ramping event time period (t₂˜t₃)
RR_{be,reco}: the ramp rate of BE power during recovering time period (t₃˜t₄)

Among those variables, the ramp rate or power change of BE power determines the ramp rate of integrated DC power output.

The battery operation policy can be optimized considering the following two objectives:
1) The ramp rate of integrated DC power (RR_{dc}) is limited within MARR;
2) The battery energy capacity is maintained around the reference setting point (E_{be, ref}) where the battery life can be maximized.

The multi-objective functions are described as:

$$\begin{matrix}min Obj = f ( {RR}_{dc} ) + f ( {E}_{be} ) \\ = {α}_{1} {{Σ}_{t = {t}_{0}}^{{t}_{n}} ( \frac{{E}_{be} ( t ) - {E}_{be , ref}}{{E}_{be , ref}} )}^{2} + {α}_{2} {{Σ}_{t = {t}_{0}}^{{t}_{n}} ( \frac{{RR}_{dc} ( t )}{MVRR} )}^{2}\end{matrix} \qquad ( 4 )$$

Where α₂, α₁ are the weight coefficients.

The following operation constraints needs to be satisfied:
The ramp rate of exported DC power is within limit

|RR_{dc}(t)|≦MARR
The battery energy level is within limits

E_{be,min}≦E_{be}(t)≦E_{be,max}
Battery power is within limit

P_{be,min}≦P_{be}(t)≦P_{be,max}

At each time instant t, when the PV power output fluctuates (ΔPₚᵥ(t), so is the exported DC power ΔP′_{dc}(t) when the battery power output (P′_{be}(t)) is kept the same as previous time step (t−1). Based the above known conditions, the battery power will be adjusted to minimize the objectives in (4) while subject to the above constraints. The online management flowchart at each time instant t is shown in FIG. 5.

As shown in FIG. 5, the process decides a battery power change ΔP_{be} at each time epoch t to minimize the control objectives in (4) while subject to all the constraints. The Reinforcement Learning (RL) technique-based approach is used to manage the battery operation during PV ramp rate control.

Next, the Reinforcement Learning-based optimization approach is detailed.

There are three elements in RL techniques: state space S, action set A, and reward functions R, the reward R is a function of S and A. There are defined as follows:
State (S)
The state space includes {(ΔP_{dc}(t), E_{be,cap} (t), P′_{BE}(t))}.
Action (A)
The action space only includes one element {ΔP_{be}(t)}, the battery power change.
Reward value (R)
The reward value is calculated at each time instant. The Reward value at t is calculated based on the collected information between t−1 and t.

$$R ( t ) = - {{α}_{1} ( \frac{{E}_{be} ( t - 1 ) - {E}_{be , ref}}{{E}_{be , ref}} )}^{2} Δ t - {{α}_{2} ( \frac{{RR}_{dc} ( t - 1 )}{MVRR} )}^{2} Δ t \qquad ( 5 )$$

The reward function is defined in a similar way as the objectives in (4). The R is defined in this way so that the energy drawn from battery and the ramp rate of exported DC power is minimized through maximizing the reward value R.

As one of the RL techniques, the Q-learning is used to find the optimal battery operation sequence which maximizes the total rewards. Q-learning uses temporal differences to estimate Q value of each state-action pair Q*(s,a). Q*(s,a) is the expected value of taking action a in state s and following the optimal policy thereafter, where the expected value means the cumulative discounted reward such as:

$${Q}^{*} ( s , a ) = {\sum }_{i = 0}^{n} {γ}^{i} {R}_{t + i}$$

Where γ is the discount factor between 0 and 1. The γ reflects how much of the future rewards are counted into total value compared with the immediate rewards. One of the advantages of Q-learning is that it does not require a model of the environment.

The action-value set Q(s,a) is learned and updated along system operation, the optimal action can determined by selecting the action with the highest Q value in each state. The update of Q(s,a) is value iteration update defined as:

$${Q}_{t + 1} ( {s}_{t} , {a}_{t} ) = {Q}_{t} ( {s}_{t} , {a}_{t} ) + {a}_{t} ( {s}_{t} , {a}_{t} ) ( {R}_{t + 1} + γ {max}_{a} {Q}_{t} ( {s}_{t + 1} , a ) - {Q}_{t} ( {s}_{t} , {a}_{t} ) ) \qquad ( 6 )$$

Where Rₜ₊₁ is the reward after performing aₜ in state sₜ, aₜ(sₜ, aₜ) is the learning rate, it could be a constant value for all state-action pair, or it varies with the state-action pair. γ is the discount factor between 0 and 1. The γ reflects how much of the future rewards are counted into total value compared with the immediate rewards.

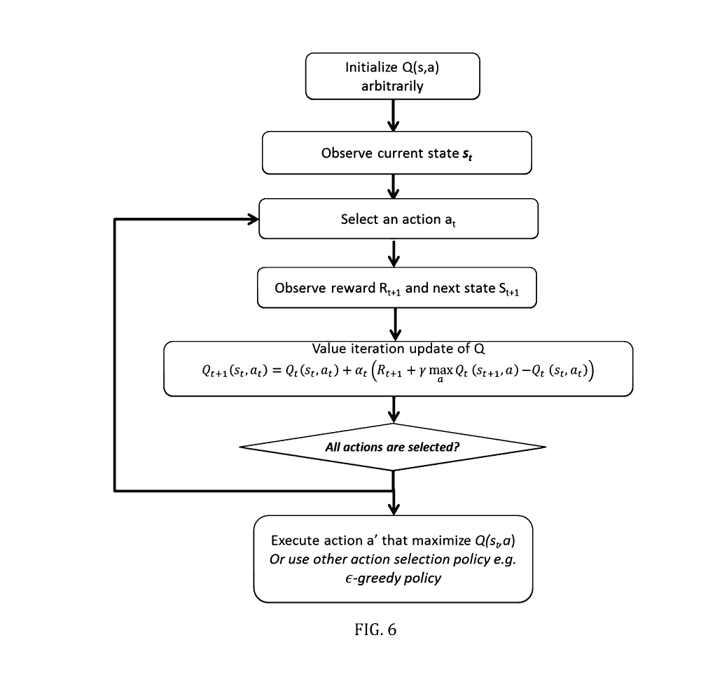

At the beginning of the Q learning, the initial value of Q for all state-action pairs can be set arbitrarily and updated iteratively later. The Q-learning procedure is illustrated in the flowchart in FIG. 6 where Q is initialized. The current state is observed and an action is selected. The process monitors the current rewards and the next state, and updates Q. This is repeated until all actions have been selected, and subsequently the process executes an action a′ that maximizes Q.

There are different policies for the action selection. The choice of these policies aims the trade-off between the exploitation and exploration phase during system operation. For example, ε-greedy policy can be chosen for the action selection during exploration phase, where the action with highest Q value is selected with probability 1−ε and the rest of the time a random action is chosen uniformly.

Mode definition is discussed next. The state-action pairs (sₜ, at) are discretely defined. The discrete modes are defined as follows.
ΔP_{dc}(t): To allow for certain level of slow variations of P_{dc}, a dead-band (|ΔP_{dc}(t)|≦ΔP_{dc,db}) is set to allow a small ramp rate of P_{dc}. Outside the dead-band, the mode of ΔP_{dc}(t) is defined at interval of P_{dc,int}.
E_{be,cap}(t): The mode of battery capacity E_{be,cap} (t) is defined at interval of E_{be,int}.
P′_{BE}(t): The mode of battery output power P_{BE}′(t) is defined at interval of P_{be,int}.
ΔP_{be}(t). The mode of control action ΔP_{be}(t) is defined at interval of ΔP_{be,int}.

The number of state-action pair modes can be chosen based on the system computation capability, the required control operation rate.

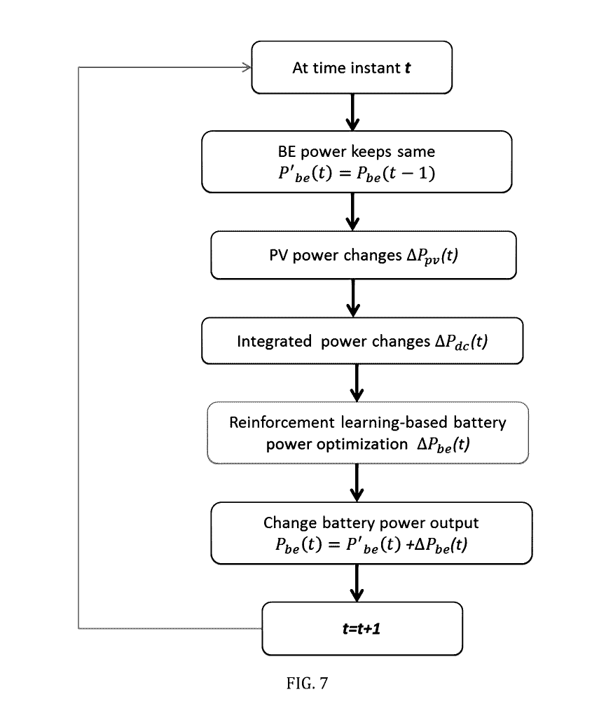

FIG. 7 shows an exemplary operation flowchart of reinforcement learning-based control method of battery storage. The system performs the RL-based power optimization and may include the following:
1. Monitor the system operation status at each time instant t {ΔP_{dc}(t) E_{be,cap} (t) P_{BE}′(t)},
2. The controller generates the control action ΔP_{be}(t), which is the battery power change. The battery operation controller applies the reinforcement learning-based optimization approaches, as illustrated in FIG. 5 and FIG. 6.
3. For the RL, the Q-learning technique is used to find an optimal battery operation sequence, where the discrete state-action (sₜ, aₜ) pairs are defined, so is the reward functions R. The Q-value for each state-action pair, which estimates the expected value of the total reward return over all successive optimal actions, is initialized and then iteratively updated along system operation. The Q-value helps determine the battery operation actions.
4. The definition of reward function R not only considers the success of suppression of PV power ramp rate, but also the deviation of battery capacity from predefined setting.

Different from the techniques used in prior art, such as low-pass filter-based approach, power curtailment, the system applies reinforcement learning-based control approach of battery storages for PV ramp rate control, which is new. The storage operation is decided dynamically to limit ramp rate of the PV power output, meanwhile the battery SoC level is maintained around predefined level to minimize the required battery size and extend the battery life cycles. This optimization-based approach does not need PV power profiles known, and can adjust the battery operation to different PV generation profiles.

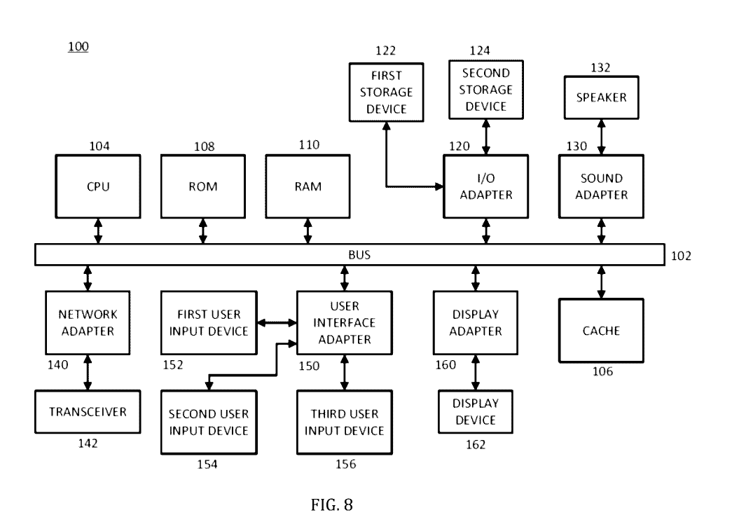

FIG. 8 shows an exemplary system for PV ramp rate control using reinforcement learning technique through integration of a battery storage system. Referring now to the drawings in which like numerals represent the same or similar elements and initially to FIG. 8, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices. A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A process for storing photovoltaic (PV) generation, comprising:
applying reinforcement learning (RL)-based control to battery storages for PV ramp rate control; and
exchanging energy dynamically to limit a ramp rate of the PV power output and maintaining a battery state of charge level at a predefined level to minimize required battery size and extend the battery life cycles.

2. The process of claim 1, comprising adjusting battery operation to different PV profiles without knowing in advance the PV profiles.

3. The process of claim 1, comprising monitoring system operation status at each time instant t {ΔP_{dc} (t), E_{be,cap} (t), P_{BE}′(t)}.

4. The process of claim 1, wherein the controller generates a battery power change control action ΔP_{be}(t). battery operation controller applies the reinforcement learning-based optimization approaches.

5. The process of claim 1, wherein for the RL, the Q-learning is used to find an optimal battery operation sequence.

6. The process of claim 1, comprising determining discrete state-action (sₜ, aₜ) pairs as estimates an expected value of a total reward return over all successive optimal actions.

7. The process of claim 4, comprising iteratively updating the Q-value for each state-action pair along system operation.

8. The process of claim 5, comprising applying the Q-value to determine battery operation actions.

9. The process of claim 1, comprising determining a reward function R as a function of suppression of PV power ramp rate and a deviation of battery capacity from predefined setting.

10. The process of claim 1, comprising determining a power balance as:
P_{dc}=Pₚᵥ+P_{be}
where battery power (P_{be}) is controlled to compensate for fluctuations of PV power generation (Pₚᵥ), so that a ramp rate of the total power output (P_{dc}) to grid can be limited within a desired level.

11. The process of claim 1, wherein a ramp-rate of P_{dc} comprises a maximum allowable ramp rate (MARR).

12. The process of claim 11, wherein the ramp rate of P_{dc} comprises:
$$\frac{d {P}_{dc}}{d t} = \frac{d {P}_{pv}}{d t} + \frac{d {P}_{be}}{d t}$$

13. The process of claim 11, wherein a sampling time interval is Δt, comprising determining
$$\frac{Δ {P}_{dc}}{Δ t} = \frac{Δ {P}_{pv}}{Δ t} + \frac{Δ {P}_{be}}{Δ t} \qquad ( 3 )$$
and the ramp rate satisfies:
$$\vert \frac{Δ {P}_{dc}}{Δ t} \vert < MARR$$
$$\vert \frac{Δ {P}_{pv}}{Δ t} + \frac{Δ {P}_{be}}{Δ t} \vert < MARR .$$

14. The process of claim 1, comprising optimizing a battery operation policy by:
limiting a ramp rate of integrated DC power (RR_{dc}) within MARR;
maintaining a battery energy capacity around a reference setting point (E_{be, ref}) where the battery life can be maximized.

15. The process of claim 1, comprising optimizing multi-objective functions with:
$$\begin{matrix}min Obj = f ( {RR}_{dc} ) + f ( {E}_{be} ) \\ = {α}_{1} {{Σ}_{t = {t}_{0}}^{{t}_{n}} ( \frac{{E}_{be} ( t ) - {E}_{be , ref}}{{E}_{be , ref}} )}^{2} + {α}_{2} {{Σ}_{t = {t}_{0}}^{{t}_{n}} ( \frac{{RR}_{dc} ( t )}{MVRR} )}^{2} ,\end{matrix}$$
where α₂, α₁ are the weight coefficients,
where
RR_{dc}: a targeted ramp rate of integrated DC power;
RR_{be,event}: a ramp rate of BE power during ramping event time period (t₁˜t₂);
RR_{be,post-event}: a ramp rate of BE power during post-ramping event time period (t₂˜t₃); and
RR_{be,reco}: a ramp rate of BE power during recovering time period (t₃˜t₄).

16. The process of claim 1, comprising determining state space S, action set A, and reward functions R, the reward R is a function of S and A, wherein a State (S) space includes {(ΔP_{dc}(t), E_{be,cap}(t), P_{BE}′(t))}, an Action (A) space only includes one element {ΔP_{be} (t)}, the battery power change, and a Reward value (R).

17. The process of claim 16, wherein the reward value is calculated at each time instant. The Reward value at t is calculated based on the collected information between t−1 and t.
$$R ( t ) = - {{α}_{1} ( \frac{{E}_{be} ( t - 1 ) - {E}_{be , ref}}{{E}_{be , ref}} )}^{2} Δ t - {{α}_{2} ( \frac{{RR}_{dc} ( t - 1 )}{MVRR} )}^{2} Δ t .$$

18. The process of claim 1, comprising applying Q-learning to find an optimal battery operation sequence to maximize the total rewards.

19. The process of claim 18, wherein the Q-learning uses temporal differences to estimate Q value of each state-action pair Q*(s,a), wherein Q*(s,a) is an expected value of taking action a in state s and following the optimal policy thereafter, where the expected value means the cumulative discounted reward with:
$${Q}^{*} ( s , a ) = {\sum }_{i = 0}^{n} {γ}^{i} {R}_{t + i}$$
where γ is a discount factor between 0 and 1.

20. The process of claim 19, wherein the action-value set Q(s,a) is learned and updated along system operation, comprising determining an optimal action by selecting the action with the highest Q value in each state and updating Q(s,a) as:
$${Q}_{t + 1} ( {s}_{t} , {a}_{t} ) = {Q}_{t} ( {s}_{t} , {a}_{t} ) + {a}_{t} ( {s}_{t} , {a}_{t} ) ( {R}_{t + 1} + γ {max}_{a} {Q}_{t} ( {s}_{t + 1} , a ) - {Q}_{t} ( {s}_{t} , {a}_{t} ) ) .$$
